(19) United States
(12) Patent Application Publication
(10) Pub. No.: US 2024/0277180 A1
(43) Pub. Date: Aug. 22, 2024

(54) MULTI-COMPARTMENT COOKING TRAY AND METHODS RELATED THERETO

(71) Applicant: H.J. Heinz Company Brands LLC, Pittsburgh, PA (US)

(72) Inventors: Lindsey KUBACKI, Chicago, IL (US); Kyra Lynn SELNER, Pittsburgh, PA (US); TszYan Chloe YENCER, Amherst, NY (US)

(21) Appl. No.: 18/571,857

(22) PCT Filed: Jun. 30, 2022
(86) PCT No.: PCT/US2022/035739

§ 371 Date: Dec. 19, 2023

Related U.S. Application Data
(60) Provisional application No. 63/217,128, filed on Jun. 30, 2021.

(51) Int. Cl. A47J 36/02; A23L 5/10; B65D 81/32; B65D 81/34

(52) U.S. Cl. CPC A47J 36/027; A23L 5/15; B65D 81/32; B65D 81/3453; B65D 2581/3404; B65D 2581/3418; B65D 2581/3498

(57) ABSTRACT

A tray for cooking different food products is provided. The tray includes a first compartment and a second compartment. A hinge extends between the first compartment and the second compartment such that the first compartment is able to be moved relative to the second compartment for causing a content within the first compartment to move into the second compartment. The tray further comprises a crisping susceptor disposed within one of the compartments.

### FIELD

This disclosure relates to trays and, in particular, to microwaveable trays for cooking food.

### BACKGROUND

Many microwaveable food products include two or more different food products packaged together to form a meal combination. For example, crispy chicken pieces or nuggets may be combined with macaroni and cheese. A problem exists in that upon microwaving the meal combination and stirring the food products as instructed, the meal combination may not have a satisfactory mouthfeel, taste, and/or texture. This is sometimes a result of the different food products having disparate preferred heating parameters, water content, or other attributes associated therewith. For example, and continuing the example above, upon microwaving the chicken pieces and macaroni and cheese, the chicken pieces or nuggets may be soggy from cooking in the presence of too much water vapor, with the water vapor helping retain the preferred cheesy mouthfeel of the macaroni and cheese. While multi-compartment trays have been developed, the associated packaging often includes lengthy instructions that requires a user to treat or manipulate the different compartments in different manners (e.g., puncturing holes, peeling film, separating components, stirring, and/or reapplying film), there remains an interest in developing easy-to-use packaging for multi-component meals that accommodates the various cooking parameters of the disparate components.

### BRIEF DESCRIPTION OF THE DRAWINGS

FIG. 1 is a top perspective view of a multi-compartment tray.

FIG. 2 is a top perspective view of the tray of FIG. 1 containing different food products in each compartment.

FIGS. 3A-D illustrate the transfer of food from one compartment of the tray of FIG. 1 into another compartment of the tray.

FIG. 4 is a top perspective of a multi-compartment tray according to a second embodiment.

FIG. 5 is a flow diagram of an example method of cooking using the tray of FIG. 1.

### DETAILED DESCRIPTION

A tray for cooking a meal combination including different food items, such as those having different textures, water content, and/or cooking requirements, is provided. The tray includes a first compartment formed by a base and sidewalls extending from the base to define a first cavity. In one illustrative configuration, a crisping susceptor is disposed within the cavity of the first compartment. The tray includes a second compartment formed by a base and sidewalls extending from the base to define a second cavity. The first cavity of the first compartment is separate from the second cavity of the second compartment. By one approach, the cooking tray includes a flange around the first and the second compartments such that the food items disposed within the first and second compartments may be separately sealed from one another. In yet another approach, the sealing flange may only be disposed around both of the first and the second compartments such that the lip or divider wall disposed between the first and second compartment does not have a film sealed thereto.

In one exemplary embodiment, the first compartment is connected to the second compartment by a hinge such that the first compartment is able to be moved relative to the second compartment for causing a content within the first compartment to move into the second compartment. For example, the dividing wall, formed by the compartment sidewalls, may have a hinge disposed thereon. Accordingly, the first and the second components are movable or pivotable relative to one another about the hinge. Further, the sidewalls forming the dividing wall between the compartments may have a sloped or angled configuration, to facilitate ejection of the food within the compartment. In addition, a sloped or angled configuration on the sidewalls of the compartment that receives the food product from an adjacent compartment can direct the food to portions of the compartment, such as a central portion thereof. By one approach, a larger slope may be employed for relatively delicate food products to which significant abrupt movement might mishappen or otherwise damage a product's crispy, flaky or other desirable configuration or texture.

In use, food items of a meal combination may be cooked using the tray. Food items to be cooked to a crispier texture, at a higher temperature, and/or at a faster rate may be placed in the first compartment and proximate the crisping susceptor. Other food items of the meal combination may be placed in the second compartment to be cooked to a softer texture, at a lower temperature, and/or at a slower rate. The tray, with the food items in the first and second compartments, may be cooked in a microwave oven. The user may or may not be instructed to remove the film sealed to the flange around the compartments. Upon completion of cooking, the contents of the first compartment may be transferred into the second compartment by moving the first compartment about the hinge (and relative to the second compartment) to slide or flip the contents of the first compartment into the second compartment. Thus, food items of a meal combination may be cooked to the desired texture and combined after the cooking process to create a multi-textured meal combination.

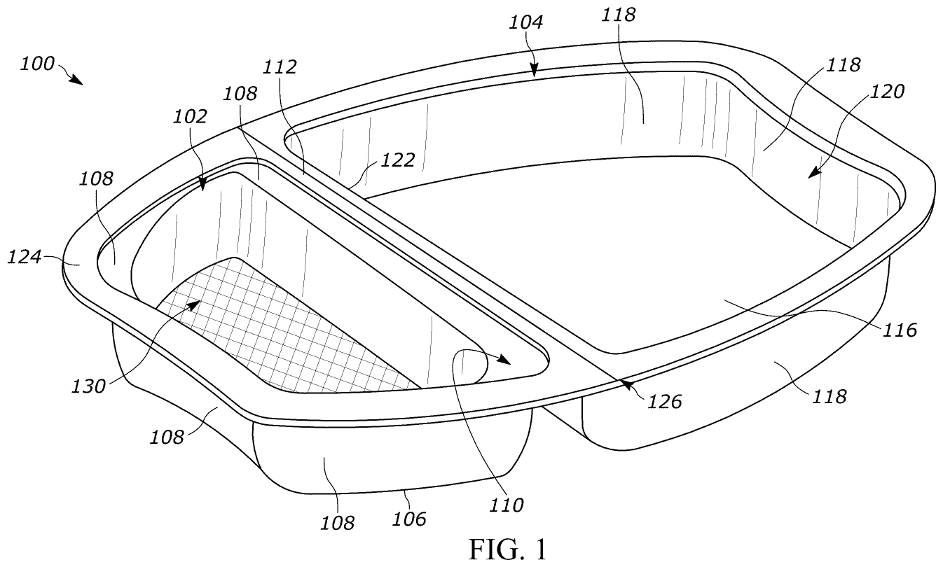

With reference to FIG. 1, a tray 100 is provided having a first compartment 102 and a second compartment 104. The tray 100 may be formed of a material such as, for example, a plastic, crystallized polyethylene terephthalate (CPET), pressed paperboard, molded fiber or a mixture (or a partial mixture) thereof. In some embodiments, the tray 100 is thermoformed. In other embodiments, the tray 100 is formed by injection molding.

In one embodiment, the first compartment 102 includes a base 106 and sidewalls 108 extending from the base 106 to form a cavity 110. The ends of the sidewalls 108 opposite the base 106 form the mouth or opening into the cavity 110. A connecting flange 112 extends from a sidewall 108 along at least a portion of the opening of the cavity 110 for connecting the first compartment 102 to the second compartment 104. As shown, the connecting flange 112 may extend substantially perpendicularly to the sidewalls 108.

The second compartment 104 includes a base 116 and sidewalls 118 extending from the base 106 to form a cavity 120. The ends of the sidewalls 118 opposite the base 116 form the mouth or opening into the cavity 120. A connecting flange 122 extends from a sidewall 108 along at least a portion of the opening of the cavity 120 for connecting the second compartment 104 to the first compartment 102. As shown, the connecting flange 122 may extend substantially perpendicularly to the sidewalls 118.

The sidewalls 108, and 118 of the first and second compartments 102, 104 may extend substantially vertically or perpendicular to their respective bases 106, 116. In some forms, the sidewalls 108, 118 may be angled, such as, for example, having a slight slope relative to the vertical, for example, about 3 degrees to about 30 degrees. In other configurations, the slope may be about 3 degrees to about 10 degrees. Including sloped sidewalls 108, 118 may aid in facilitating the transfer of food contents between the first compartment 102 and the second compartment 104, described in further detail below. Including a slight slope to the sidewalls 108 may also aid in removing the tray 100 from a mold when the tray 100 is formed by injection molding. Furthermore, the angle of the sidewall may be selected, in part, in light of the food products that will be evacuated from the compartment.

The base 106 may have a configuration such that a portion of the base 106 spaces food contents within the first compartment 102 from the surface on which the tray 100 rests. This may aid to prevent the surface of the microwave on which the tray 100 is placed (e.g., a microwave turntable) from absorbing the heat from the tray 100 and the food contents during microwave cooking. For example, the base 106 may have a portion that is elevated, such as via a dome shape or other upwardly projecting portion, that extends vertically into the first compartment 102. As another example, the base 106 may include an array of raised parallel extending bars or lines that extend laterally and/or longitudinally within the base 106, for example, which may be representative of a grille to space the food contents from the surface on which the tray 100 is placed. Including crisping susceptors 130 on each of these raised bars or lines may provide cooking marks or lines on the food product similar to the marks that results from cooking on a grille. Also, grease and moisture may drain to the bottom portion of the compartment 102 and away from the food product during cooking. The base 116 of the second compartment 104 may similarly have a configuration spacing the food contents of the second compartment 104 from the surface on which the tray 100 is placed to aid in cooking.

The base 106 and/or sidewalls 108 of the first compartment 102 may include fins or lugs extending from an outer surface thereof for spacing the tray 100 from another tray 100 when the trays 100 are stacked upon one another. Similarly, the base 116 and/or sidewalls 108 may include fins or lugs extending from an outer surface thereof for spacing the tray 100 from another tray 100 when stacked. This may be particularly useful during processing of the food product before it is shipped to grocery stores or directly to consumers.

The tray 100 may also include a flange 124 that extends about the periphery of the tray 100. In the embodiment of FIG. 1, the flange 124 extends about at least a portion of the sidewalls 108 of the first compartment 102 and at least a portion of the sidewalls 118 of the second compartment 104. The flange 124 may extend substantially perpendicular to the sidewalls 118 and outward from the first and second compartments 102, 104. The flange 124 may provide a sealing surface against to which a film 125 may be attached to seal the contents in the first and second compartments 102, 104. The flange 124 further forms a portion of the tray 100 that a user may use to handle or grasp the tray 100. For instance, upon microwaving the tray 100, the user may grasp the flange 124 to transport the tray 124 as the flange 124 may be cooler than other portions of the tray 100.

The first compartment 102 is connected to the second compartment 104 by a strip of tray materials that is connected to the sidewalls or flanges of the compartments. Upon this strip of material, a hinge 126 is disposed on or near at least a portion thereof. By one approach, the hinge 126 enables the first compartment 102 to be moved relative to the second compartment 104 about the hinge 126. The hinge 126 may be a living hinge formed between the connecting flange 112 of the first compartment 102 and the connecting flange 122 of the second compartment 104. In other embodiments, a first leaf of the hinge 126 is affixed (e.g., by an adhesive or weld) to the connecting flange 112 of the first compartment 102 and a second leaf of the hinge 126 is affixed (e.g., by an adhesive or weld) to the connecting flange 122 of the second compartment 104. In yet other embodiments, the hinge 126 may be formed by a partial depth die cut, score, and/or perforation within the strip of material forming the connecting flanges 112, 122. In some forms, the cut, score, and/or perforation may permit the first compartment 102 to be detached from the second compartment 104 by tearing there along to separate the compartments 102, 104.

In some embodiments, the connecting flanges 112, 122 of the compartments 102, 104 are substantially straight and extend across the width of the tray 100. By one approach, the hinge 126 extends between the flanges 112, 122 along the width of the tray 100. In some forms, the hinge 126 extends along a portion of the width of the tray 100. In other forms, the hinge 126 extends from one edge of the tray 100 to another edge of the tray 100. In other embodiments, two or more hinges 126 may be disposed along the length of the connecting flanges 112, 122 to movably join the two compartments 102, 104 together.

The tray 100 further includes a crisping susceptor 130 within the first compartment 102. The crisping susceptor 130 includes a susceptor layer that includes a microwave energy interactive material. By one approach, the crisping susceptor is a single piece of material disposed on the base of the compartment, but in yet other approaches, the crisping susceptor may include several discrete portions of material. When positioned within a microwave for cooking, the crisping susceptor 130 typically absorbs the microwaves which raises the temperature of the susceptor to higher levels to aid in crisping and/or heating of the food positioned proximate the crisping susceptor 130 by conduction or infrared radiation. In one illustrative approach, the susceptor 130 includes one or more metallized poly-film lamination layers, paper layers, and/or polymer layers, which may be disposed on the bottom thereof. More specifically, in one example the susceptor layer includes a multilayer flexible structure having at least a top product-contacting layer with a metallized material having the microwave energy interactive material thereon and a paper layer (which may include additional paper or poly-layers for functionality). In another example, the multilayer flexible structure of the susceptor layer further includes an additional polymer layer. The susceptor layer of the crisping susceptor 130 may have a thickness of between about 0.002-in. to about 0.020-in.

In the embodiment shown in FIG. 1, the crisping susceptor 130 is positioned on the base 106 of the first compartment 102 within the cavity 110. In some forms, the crisping susceptor 130 may be attached to the base 106 by an adhesive. The adhesive may be, as examples, a polyamide hot melt and/or a starch based cold glue adhesive. In other forms, the crisping susceptor 130 may not be affixed to the base 106, but may be movable within the first compartment 102. This may be advantageous where use of the crisping susceptor 130 is optional to the user enabling the user to remove the crisping susceptor 130 if desired. In some forms, the crisping susceptor 130 is a sleeve, box or other container surrounding the food product on multiple sides that a food product is inserted into for crisping when microwaved. The crisping susceptor 130 may be removable to allow a user to insert and/or withdraw the food product from the crisping susceptor sleeve, box, or other container. In some forms, the crisping susceptor 130 forms a lid covering the opening to cavity 110 of the first compartment 102.

In some embodiments, the crisping susceptor 130 further extends along the sidewalls 108 of the first compartment 102. Depending on the desired food properties, the crisping susceptor 130 may cover a substantial portion of the interior of the cavity 110 of the first compartment 102. This may be advantageous where additional heating from the sides of the compartment 102 is desired in addition to the base 106. In still other embodiments, the crisping susceptor 130 extends along the sidewalls 108 about the base 106, but does not cover the base 106. This configuration may be desirable where heating by radiation is desired, but heating by conduction (e.g., direct contact between the food product and the crisping susceptor) is not desired.

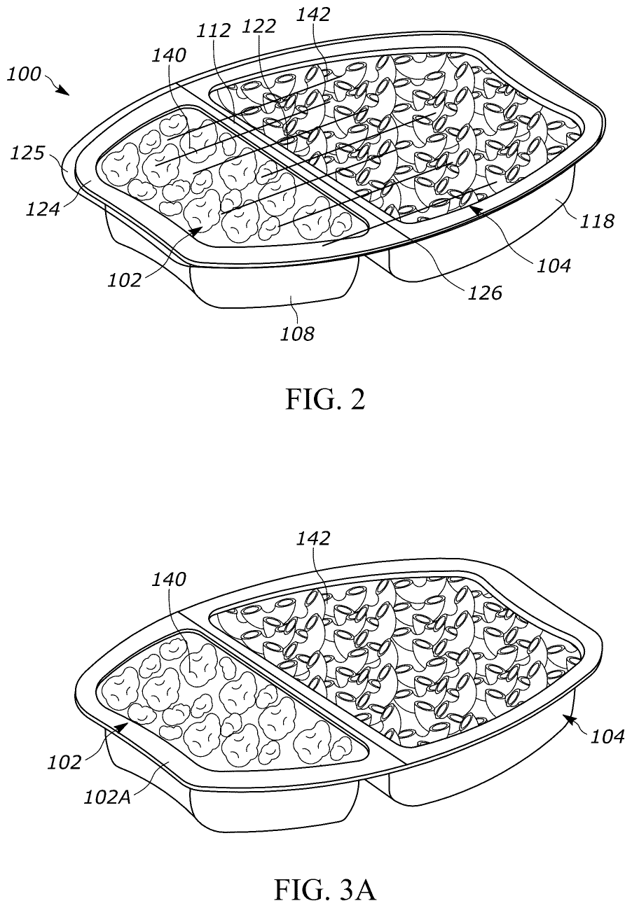

Food products may be placed within the first compartment 102 and the second compartment 104 of the tray 100 for cooking and consumption. Because the first compartment 102 includes a crisping susceptor 130 and the second compartment 104 does not typically include a crisping susceptor (or at least not a substantial crisping susceptor), food products in the first compartment 102 will be cooked differently when microwaved than food products in the second compartment 104. The enables food products of different textures and moistures to be cooked at the same time while being cooked in a manner that achieves the desired texture and moisture level for each food product at the end of the microwave cooking process. For example, and with reference to FIG. 2, both chicken pieces or nuggets 140 and noodles 142 may be cooked at the same time. Since it is often desired to have crispy chicken pieces or nuggets 140, the chicken pieces or nuggets 140 may be placed in the first compartment 102 where the crisping susceptor 130 will crisp the chicken nuggets 140 during microwaving. The noodles 142 may be cooked in the second compartment 104, separated from the chicken pieces or nuggets 140, to be cooked to be a soft texture as is often desired for noodles. Being cooked in separate compartments, moisture from the noodles 142 or accompanying sauce is not able to seep into the chicken pieces or nuggets 140 during cooking (specifically the crispy breading disposed around the meat), which would cause the chicken pieces or nuggets 140 to become soggy rather than crispy as typically desired. Moreover, the chicken pieces or nuggets 140 will be crisped by the crisping susceptor 130 within the first compartment 102, while the noodles 142 will remain moist during cooking being cooked in the second compartment 104 without a susceptor.

Other combinations of food products may similarly be cooked using the tray 100 to cook various food items of a meal combination to a desired crispness/moistness and texture. The food products desired to be cooked to a crispy texture or more quickly may be cooked in the first compartment 102 while the food products desired to be cooked to a softer texture or that have a shorter cooking time may be cooked in the second compartment 104. The below table provides examples of various meal combinations comprising two or more food items that are able to be properly cooked using the tray 100) by cooking certain food items of the combination in the first compartment 102 and other food items in the second compartment 104.

| | Food Component | Food Component |
|---|---|---|
| | Cooked in First | Cooked in Second |
| Meal Combination | Compartment | Compartment |
| Chicken and Mac & | Crispy Breaded | Mac & cheese made |
| Cheese | Chicken | with one or more |
| | | cheeses and pasta |
| | | noodles |
| Chicken Parmesan | Crispy breaded | Penne pasta tossed in a |
| with Creamy | chicken and | creamy garlic alfredo |
| Alfredo | mozzarella cheese | sauce |
| Chicken & Waffles | Crispy popcorn | Maple waffles with a |
| | chicken | maple and/or bacon |
| | | glaze or syrup |
| Nacho Bowl | Mini tortilla chips | Toppings such as |
| | | Angus beef, corn, |
| | | black beans, and/or |
| | | roasted jalapeno queso |
| Fried Chicken and | Fried chicken coated | Side of fried rice and |
| Rice | in a sauce | green onions and/or |
| | | peppers. |
| Crispy Beef and | Crispy slices of beef | Fried noodles |
| Noodles | coated in a sauce | |
| Fried appetizer, | Crispy egg rolls filled | Dipping sauce |
| such as, egg rolls, | with, e.g., angus beef, | |
| pot stickers, French | chicken, cabbage, red | |
| fries, or Chimichangas | peppers, jalapenos, | |
| | corn, rice, and/or cheese | |
| Pastry or breads with | Pretzel pieces | Dipping sauce such as |
| sauce, such as Pretzel | | cheese, frosting, |
| Bites | | and/or mustard |
| Wings | Crispy wings | Dipping sauce |

While the first compartment 102 and the second compartment 104 of the tray 100 are shown having four sidewalls, in other embodiments the first and second compartments 102, 104 may have alternative shapes and any other number of sidewalls. For example, the compartments 102, 104 may have a rectangular, triangular, circular, ovoid, oval, heart, or other shape. Regardless of the shape, the compartments 102, 104 are joined together by a strip of material that incorporates a hinge 126 extending between the compartments 102, 104 that facilitates movement of the first compartment 102 relative to the second compartment 104 to transfer the contents of the first compartment 102 into the second compartment and vice versa.

Moreover, while the first compartment 102 is described as including a crisping susceptor 130 enabling a food item cooked in the first compartment 102 to be cooked to a different texture/moisture than a food item cooked in the second compartment 104, it should be understood that the second compartment 104 may also include a crisping susceptor. The crisping susceptor of the second compartment 104 may have a different shape or arrangement within the second compartment 104 than the crisping susceptor 130 of the first compartment 102 to achieve a different texture/moisture. The different shapes and arrangements may be similar to the different shapes and arrangements described above with regard to the crisping susceptor 130 of the first compartment 102. The crisping susceptor 130 of the second compartment 104 may have microwave absorption and/or impedance properties that are different than the crisping susceptor 130 of the first compartment 102 resulting in different browning or crisping effect on the food items in each compartment.

Each compartment 102, 104 may also include a film or pad for absorbing grease or moisture from the food items as they are cooked. In some forms, the first compartment 102 may include a crisping susceptor 130 while the second compartment 104 includes a grease or moisture absorber. In some forms, the first compartment 102 may include a crisping susceptor 130 along with a grease or moisture absorber to draw the grease/moisture away from the food item as it cooks. For example, the crisping susceptor 130 may be placed on a grease absorbing film. The crisping susceptors 130 may include vias or holes extending through the crisping susceptor 130 permitting the fluid emitted from the food item during cooking to pass through the crisping susceptor 130 to the grease absorber.

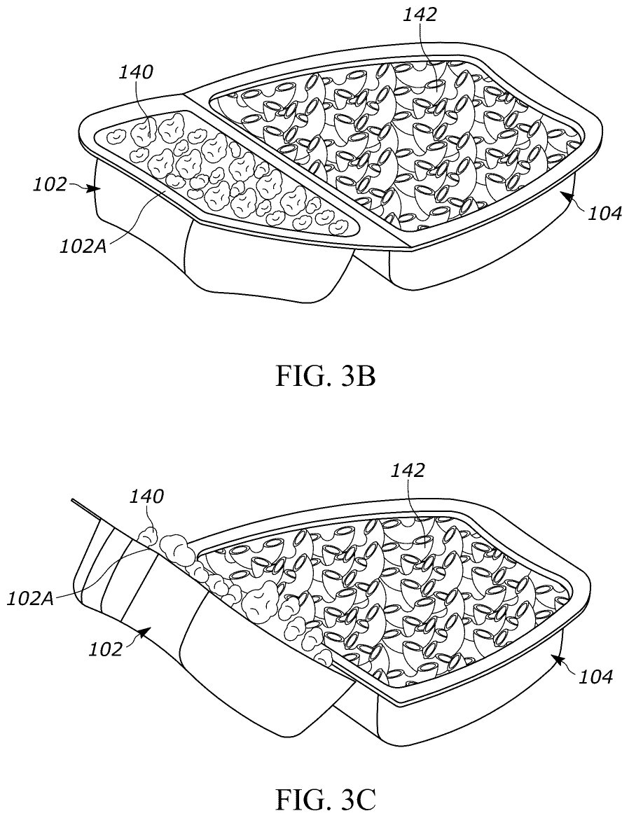

With respect to FIGS. 3A-D, the first compartment 102 of the tray 100 is shown being progressively rotated about the hinge 126 to transfer the chicken pieces or nuggets 140 into the noodles 142. In FIG. 3A, the tray 100 is shown in an initial position where the flange 124 surrounding the periphery of the tray 100 is substantially planar. The base 106 of the first compartment 102 and the base 116 of the second compartment 104 may be substantially parallel with one another and configured to both engage a surface (e.g., countertop, table, microwave turntable, etc.) at the same time to support the tray 100 on the surface. As shown in FIGS. 3B-D, the first compartment 102 may be manually, progressively moved relative to the second compartment 104 causing a portion of the flange 124 about the first compartment 102 to be at an angle with a portion of the flange about the second compartment 104. Similarly, the bases 106, 116 of the first and second compartments 102, 104 may be rotated at an angle to one another. To rotate the first compartment 102 about the hinge 126 a user may grasp or move an end 102A of the first compartment 102 opposite the hinge 126 about the hinge 126. In some forms, the first compartment 102 may be rotated until it is perpendicular to the second compartment 104. In other forms, the first compartment 102 may be rotated approximately 180 degrees until the portion of the flange 124 surrounding the first compartment 102 contacts or nearly contacts the portion of the flange 124 surrounding the second compartment 104 such that the tray 100 has a clamshell configuration. As the first compartment 102 is rotated while the second compartment 104 is maintained in a substantially horizontal position (e.g., on a flat surface such as a countertop or table), the base 106 of the first compartment 102 forms a slope on which contents of the first compartment travel from the first compartment 102 toward the second compartment 104. Once the slope is great enough, the contents of the first compartment 102 may travel over the hinge 126 and into the second compartment 104.

Thus, upon cooking the contents of the tray 100, the food contents cooked in the first compartment 102 may be transferred to the second compartment 104. In this way, the crispy food items of the first compartment 102 may be transferred in with the food items that have different textures in the second compartment 104 without the user having to manually transfer the crispy food items, for example, by using a fork, while the food items are hot. A user may then mix the food items together in the second compartment 104 if desired. Thus, the tray 100 permits a user to cook food items with different textures while still being able to combine the food items into a final meal combination they desire. Using the tray 100, the meal combination may have multiple textures (e.g., both crispy and soft), as opposed to trays where the food items were cooked together resulting in a substantially single texture food mixture.

In another form, the tray 100 may be used to cook a food item in stages with different cooking properties in each stage. For example, the food item may be cooked in the second compartment 104 for a period of time. The food item may then be transferred into the first compartment 102, for example, by flipping the food item into the first compartment 102 about the hinge as described above. The food item may then be cooked in the first compartment 102 on the crisping susceptor to achieve the desired texture or crispiness.

The tray 100 may be packaged as a fresh or frozen meal, with each compartment 102, 104 being filled with food items of a meal combination and frozen for distribution. Upon filling the compartments 102, 104 of the tray 100, a film 125 may be sealed to the flange 124 about the compartments 102, 104 to seal the contents within the tray 100. The film 125 may also be sealed to the connecting flanges 112, 122 to seal each compartment 102, 104 individually. This may prevent the contents of one compartment from traveling into the other compartment during packaging and/or distribution. The film may be formed of PET (polyethylene terephthalate) or a PET/PE (polyethylene) co-extrusion, as examples. The film 125 may be sealed to the tray by heat sealing or an adhesive as examples. The tray 100, film, and seal may be configured to withstand a wide range of temperatures and drastic temperature changes. For example, the film may be configured to remain sealed to the tray 100 at freezing temperatures and up to high cooking temperatures, for example, about −40 F to about 230 F.

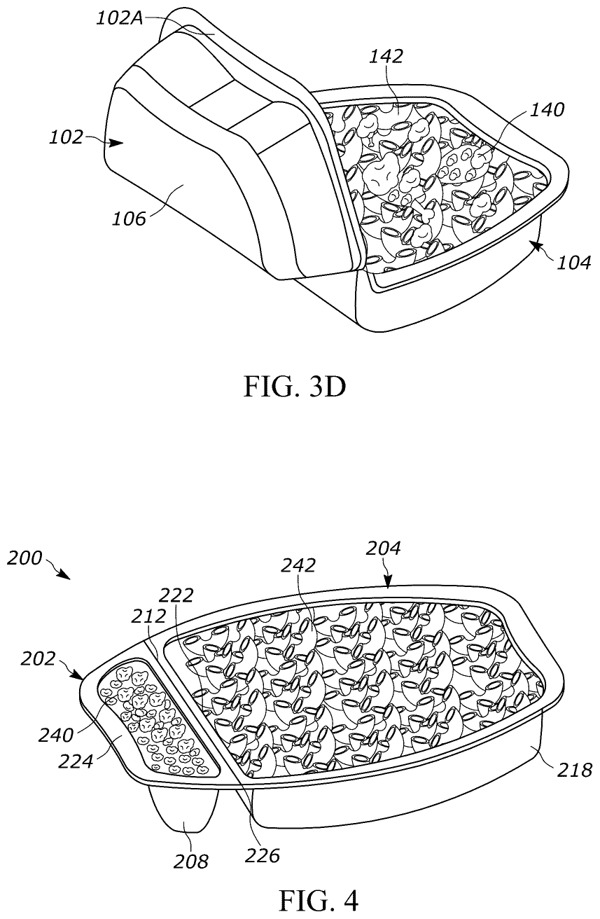

With respect to FIG. 4, a tray 200 is shown according to another embodiment having a first compartment 202 and second compartment 204 of a different size than that of the tray 100 of the embodiment of FIG. 1. For simplicity, the reference numerals used with regard to the first embodiment will be used to indicate features of the tray 200 of the second embodiment, with the prefix of the reference numerals changed from a “1” to a “2.” For example, a feature shown as “102” with regard to the tray 100 of the first embodiment will be shown as “202” with regard to the tray 200 of the second embodiment.

As shown, the first compartment 202 is smaller relative to the second compartment 204 than in the previous embodiment of the tray 100. The tray 200 has volume ratio of the second compartment 204 to the first compartment 202 that is higher than that of the tray 100. This may be desired for meal combinations having a significantly smaller amount of food content to be cooked to a higher temperature and/or to a crispy texture. For example, where the meal combination is noodles and cheese 242 with bacon bits 240, a relatively small volume of bacon bits 240 may be added to the noodles and cheese 242 to provide a desirable ratio of bacon bits 240 to noodles and cheese 242. The first compartment 202 may be rotated about the hinge 226 to add the contents of the first compartment 202 to the second compartment 204 as described with regard to the first embodiment.

While two embodiments of the tray 100 are shown, those having skill in the art will appreciate that the size of each of the first compartment 102 and second compartment 104 may be adjusted relative to one another to provide compartments sized to contain a ratio of food contents for a particular meal combination. The two compartments may be hingedly connected to one another as described above to transfer the contents from one compartment to the other. While the transfer of food contents has primarily been described as from the first compartment 102 to the second compartment 104, those having skill in the art will readily appreciate that the contents of the second compartment 104 may similarly be transferred into the first compartment 102 by rotating the second compartment 104 about the hinge 126 to slide or dump the contents of the second compartment 104 into the first compartment 102. This may be desirable where the first compartment 102 is larger in size than the second compartment 104 and able to contain the contents of both the first and second compartments 102, 104.

While the embodiment of the tray 100 shown include two compartments, in other embodiments, the tray 100 may include additional compartments. For instance, the tray 100 may include three compartments configured to cook three different food contents separately from one another. This may enable the food contents of each compartment to be cooked to three different textures (e.g., a different texture in each compartment). In some forms, the contents of multiple compartments of a tray 100 may be transferred into a single compartment as described above. For example, a tray 100 may include three compartments arranged along the length of the tray 100. The compartments on the ends of the tray 100 may be connected to the middle compartment by a hinge enabling the contents of the end compartments to be emptied into the middle compartment by moving the end compartments about the respective hinges 126.

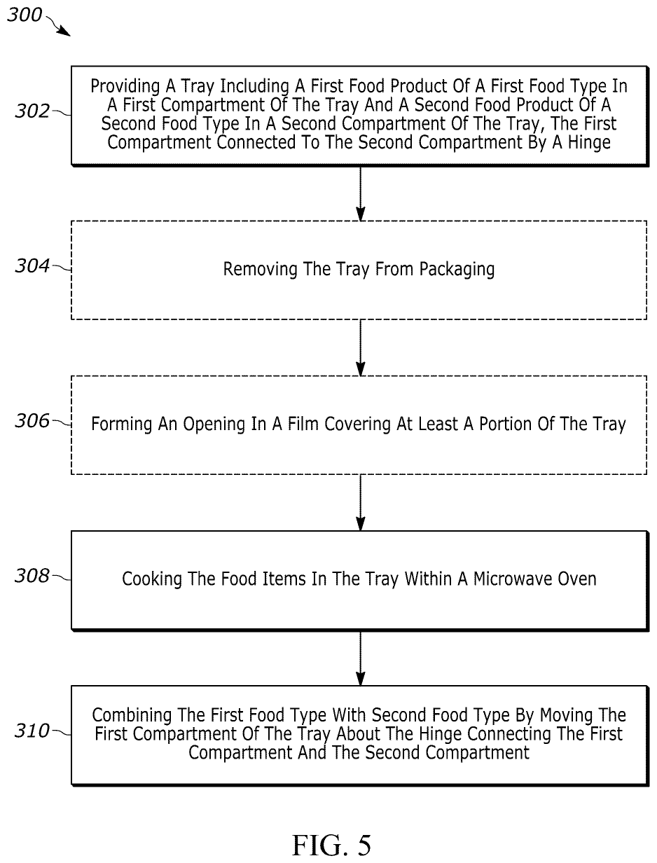

In use, the tray 100 may be used for cooking a meal combination according to method 300 shown in FIG. 5. The user may provide 302 a tray 100 including food of a meal combination with a first food type in the first compartment 102 and a second food type in the second compartment 104. The food may be sealed in the tray 100 by a film 125 on the flange 124 of the tray 100 and packaged, for example, within a box. The user may remove 304 the tray 100 from the packaging 136.

The user may then form 306 an opening into the first compartment 102 and/or second compartment 104. In some forms, the user may remove the film 125 from the tray 100. In other forms, the user may remove the film from covering the contents of either the first compartment 102 or the second compartment 104. For instance, the user may peel a portion of the film covering the first compartment 102 so that the steam generated during cooking escapes the first compartment 102, enabling the food items to get crispier during cooking. In other forms, the user may slit the film 125 to create an opening into the first compartment 102 and/or second compartment 104 through the film 125.

The user may then place the tray 100 within the microwave oven and cook 308 the meal combination in the tray 100 for a period of time to sufficiently cook the food contents in both the first and second compartment 102, 104. As an example, the meal combination may be cooked in an 1100 W microwave oven for a time period in the range of about one minute to about ten minutes. The first compartment 102 may include a crisping susceptor 130 selected to heat the food items at a certain rate or arranged to contact the food items within the first compartment 102 such that the contents the first compartment 102 and the second compartment 104 complete cooking at approximately the same time. Where the tray 100 includes additional compartments, each compartment may be configured to cook the food items disposed therein at a rate such that a single cooking time is required to properly and fully cook all food items within the tray 100 to completion at the same time.

In some embodiments, the meal combination may be cooked in the microwave oven in two or more steps. For instance, the tray 100 may be cooked in the microwave for a first period of time and then for a second period of time. In between the first and second cooking steps, the food items in the second compartment 104 may be mixed or stirred. As another example, in between the first and second cooking steps, the food items in the first compartment 102 may be flipped such that a different portion of the food item is in contact with the crisping susceptor 130 during the second cooking step. In other embodiments, additional steps of cooking may be used with the food items being stirred, mixed, and/or flipped in between cooking steps. In some forms, the film may be removed from the tray 100 in between cooking steps.

Once the meal combination has been fully cooked, the meal combination may be ready for consumption. Once cooked, a user may combine the contents of the first compartment 102 and the second compartment 104. A user may use the tray 100 to combine 310 the food contents by transferring the contents of the first compartment 102 into the second compartment 104. To do this, the user may move an end 102A of the first compartment 102 opposite the hinge 126 upward and about the hinge 126. The user may rotate the first compartment 102 about the hinge 126 until the contents of the first compartment 102 slide over the hinge 126 and into the second compartment 104 or fall from the first compartment 102 and into the second compartment 104. In some forms, the contents of the first compartment 102 may be transferred to the second compartment 104 in between cooking steps.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

What is claimed is:

1. A tray for cooking multi-textured food products, the tray comprising:
a first compartment having a first base and first sidewalls extending from the first base to define a first cavity, the ends of the first sidewalls opposite the first base forming a first opening into the first cavity, a flange disposed about at least a portion of the first opening;
a second compartment having a second base and second sidewalls extending from the second base to define a second cavity separate from the first cavity, the ends of the second sidewalls opposite the second base forming a second opening into the second cavity, the flange disposed about at least a portion of the second opening;
a hinge extending between the first compartment and the second compartment such that the first compartment is able to be moved relative to the second compartment for causing a content within the first compartment to move into the second compartment; and
a crisping susceptor disposed within the first compartment.

2. The tray of claim 1 wherein the hinge extends through at least a portion of a width of the flange between the sidewalls of the first and second compartments.

3. The tray of claim 2 wherein the hinge extends from a first edge to a second edge.

4. The tray of claim 1 wherein the first compartment and the second compartment are formed of a rigid material and the hinge is formed in the rigid material.

5. The tray of claim 1 wherein the second compartment does not include a crisping susceptor.

6. The tray of claim 1 wherein the hinge is a living hinge.

7. The tray of claim 1 wherein the crisping susceptor is affixed to the first base of the first compartment.

8. The tray of claim 7 wherein the first base is configured to engage a surface, the first base including a portion spaced apart from the surface.

9. The tray of claim 1 wherein the crisping susceptor is positioned to engage a food item, wherein the crisping susceptor draws moisture out of the food item when microwaved to crisp the food item.

10. The tray of claim 1 further comprising a film sealed to the flange and covering the first compartment and second compartment to seal the first cavity and second cavity.

11. The tray of claim 1 further comprising a first food item disposed in the first compartment and a second food item disposed in the second compartment.

12. The tray of claim 4 wherein the rigid material is a thermoformed plastic and the hinge is formed in the thermoformed plastic.

13. A method of cooking food, the method comprising:
providing a tray having a first compartment and a second compartment connected by a hinge, a crisping susceptor and a first food product of a first type disposed within the first compartment and a second food product of a second food type disposed within the second compartment, the first food product adjacent the crisping susceptor;
cooking the first and second food products in the tray with a microwave oven;
combining the first food product with the second food product by moving the first compartment relative to the second compartment about the hinge to transfer the first food product into the second compartment.

14. The method of claim 13 wherein the first food product is different than the second food product.

15. The method of claim 13 further comprising mixing the first food product into the second food product in the second compartment.
